(19) United States
(12) Patent Application Publication
(10) Pub. No.: US 2005/0052777 A1
(43) Pub. Date: Mar. 10, 2005

(54) Method and apparatus for positioning head using servo burst signals in a disk drive

(75) Inventor: Akio Toda, Kitatsuru-gun (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/932,315

(22) Filed: Sep. 2, 2004

(30) Foreign Application Priority Data
Sep. 3, 2003 (JP) 2003-311595

(51) Int. Cl. G11B 5/596

(52) U.S. Cl. 360/77.08; 360/78.04

(57) ABSTRACT

There is disclosed a disk drive using a disk in which servo data is recorded, wherein a CPU executes control to position a head by use of a servo burst calculation result and a difference value from a target cylinder at the time of on-track control in the head positioning control.

### CROSS-REFERENCE TO RELATED APPLICATIONS

This application is based upon and claims the benefit of priority from prior Japanese Patent Application No. 2003-311595, filed Sep. 3, 2003, the entire contents of which are incorporated herein by reference.

### BACKGROUND OF THE INVENTION

1. Field of the Invention

The present invention relates generally to a disk drive, particularly to a control technique for positioning a head using servo data.

2. Description of the Related Art

In general, in a disk drive represented by a hard disk drive, control (servo control) is executed to position a head using servo data recorded on a disk medium (hereinafter referred to simply as the disk).

The servo data is roughly classified into a cylinder code for identifying each track (cylinder) constituted on the disk, and a servo burst signal for detecting a position of the head on the track.

A microprocessor (CPU) which is a main control device of the disk drive selectively detects an absolute position by a cylinder code and a relative position by the servo burst signal to detect a so-called total head position. The CPU executes seek control for moving the head to a target track, and on-track control (or track following control) for positioning the head on the target track based on the detected position of the head.

Additionally, the CPU switches a position calculation for detecting the position of the head at the time of the seek control or the on-track control. Therefore, there are problems such as a transient response accompanying the switching of the position calculation. There is a problem that it is difficult to secure linearity over a broad range in the position calculation (hereinafter referred to as the servo burst calculation) using the servo burst signal in order to calculate position information of the head on the track (see Jpn. Pat. Appln. KOKAI Publication No. 11-195280, for example).

It is difficult to solve the problem of the transient response in the servo burst calculation especially at the time of the on-track control, or to secure the linearity in the control for positioning the head of the disk drive.

### BRIEF SUMMARY OF THE INVENTION

In accordance with one embodiment of the present invention, there is provided a disk drive including facilities to realize head positioning control for executing a position calculation by use of a cylinder code together with a servo burst signal at the time of on-track control.

The disk drive comprises: a head to perform a read operation and a write operation of data with respect to a disk medium in which servo data including a cylinder code and a servo burst signal is recorded; an actuator on which the head is mounted and which moves the head in a radial direction on the disk medium; a first servo calculation unit which executes a servo burst calculation to calculate a position error of the head by use of the servo burst signal reproduced by the head at the time of an on-track control to position the head on a track designated by a target cylinder code; a second servo calculation unit which calculates a difference between a target cylinder and a current cylinder in accordance with the cylinder code reproduced by the head at the time of the on-track control; and a controller which drives/controls the actuator to execute the on-track control of the head by use of a result of the servo burst calculation and a value of the difference.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a main part of a disk drive according to an embodiment of the present invention;

FIGS. 2A and 2B are diagrams showing a disk format according to the present embodiment;

FIG. 3 is an explanatory view of on-track control according to the present embodiment;

FIGS. 4 to 8 are explanatory views of a servo burst calculation method according to the present embodiment;

FIG. 9 is an explanatory view of table information according to the present embodiment; and

FIG. 10 is a flowchart showing a procedure of head positioning control according to the present embodiment.

### DETAILED DESCRIPTION OF THE INVENTION

An embodiment of the present invention will be described hereinafter with reference to the drawings.

(Constitution of Disk Drive)

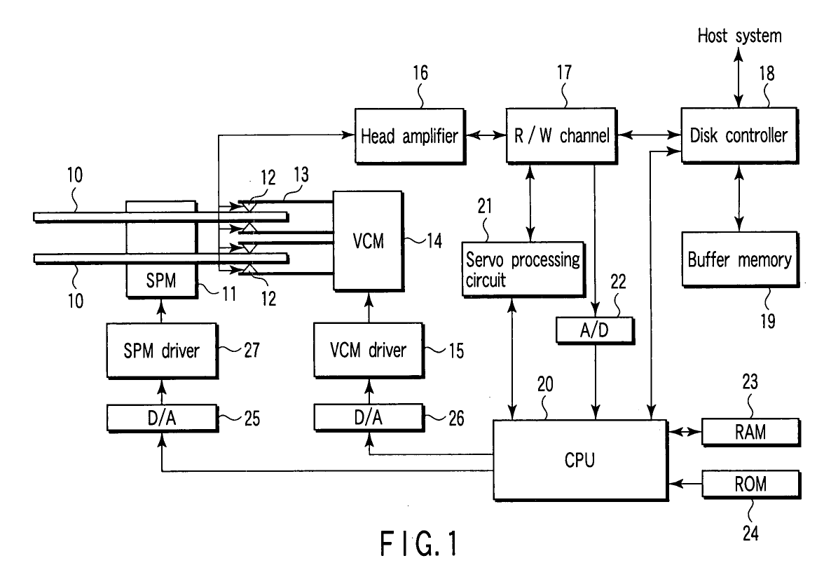

FIG. 1 is a block diagram showing the main part of a disk drive according to the present embodiment.

The disk drive includes a spindle motor (SPM) 11 which rotates disks 10, heads 12 which read/write data, and an actuator 13 on which the heads 12 are mounted. The actuator 13 is driven by a voice coil motor (VCM) 14 to move the heads 12 in the radial direction of the disks 10. The SPM 11 and the VCM 14 are driven by an SPM driver 27 and a VCM driver 15, respectively.

Furthermore, the disk drive includes a head amplifier 16, a read/write (R/W) channel 17, a disk controller 18, and a microprocessor (CPU) 20.

The head amplifier 16 transmits a read/write signal between the heads 12 and the R/W channel 17. The head amplifier 16 amplifies servo signals (servo data recorded on the disks 10) read by the heads 12 to send the signals to the R/W channel 17. The R/W channel 17 executes signal processing (coding or decoding) of the servo and data signals. The disk controller 18 has an interface function between the disk drive and a host system, and controls transfer of read/write data using a buffer memory 19.

The CPU 20 is a main control device of the drive, and executes a program stored in a ROM 24, or executes head positioning control according to the present embodiment by use of a RAM 23 as a work memory.

The CPU 20 inputs a Gray code (cylinder code sector code) included in the servo signal output from the R/W channel 17 via an analog-to-digital (A/D) converter 22. The CPU 20 inputs a result of a servo burst calculation described later from a servo processing circuit 21. The servo processing circuit 21 executes the servo burst calculation using a servo burst signal included in the servo signal output from the R/W channel 17.

The CPU 20 executes the head positioning control using the Gray code and the servo burst calculation result, and supplies an operation control value for controlling the VCM 14 to the VCM driver 15 via a digital-to-analog (D/A) converter 26. The CPU 20 supplies an operation control value for controlling the SPM 11 to the SPM driver 27 via a digital-to-analog D/A converter 25.

(Disk Format)

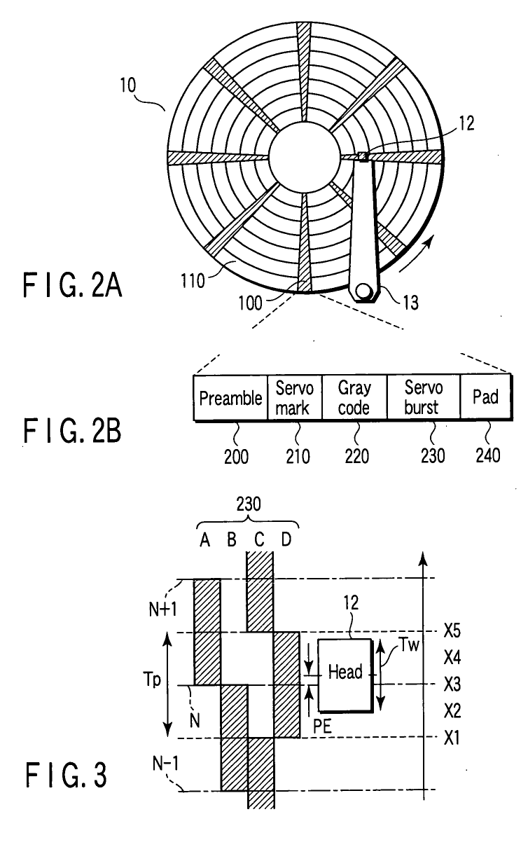

As shown in FIG. 2A, servo areas 100 in which servo data is recorded are disposed at predetermined intervals in a circumferential direction on the disk 10. On the other hand, a large number of tracks (cylinders) 110 including the respective servo areas 100 are constituted in a radial direction on the disk 10. A plurality of data sectors in which user data is recorded are disposed between the servo areas 100 in each track 110.

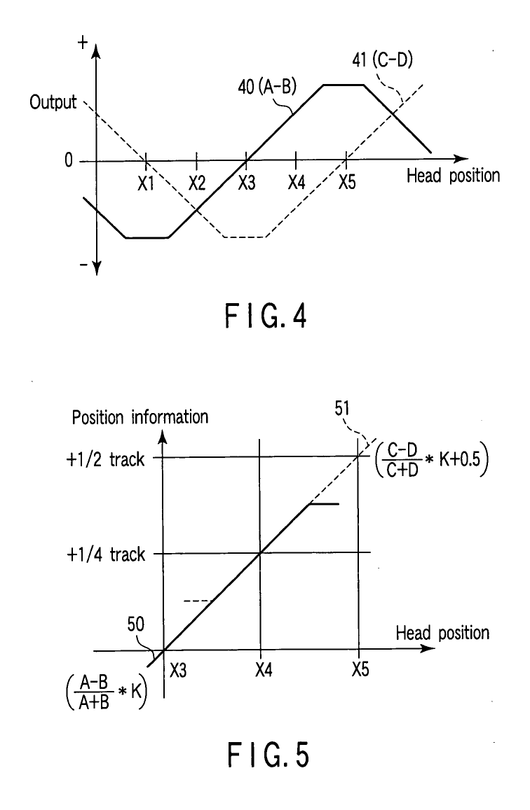

As shown in FIG. 2B, the servo data recorded in the servo area 100 is constituted of a preamble 200, a servo mark 210, a Gray code 220, a servo burst signal 230, and a pad 240. The Gray code 220 includes a cylinder code for identifying the track, and a sector code for identifying a data sector. As shown in FIG. 3, the servo burst signal 230 is a signal for detecting the position of the head on the track, and is constituted, for example, of four-phase bursts A to D.

(Head Positioning Control)

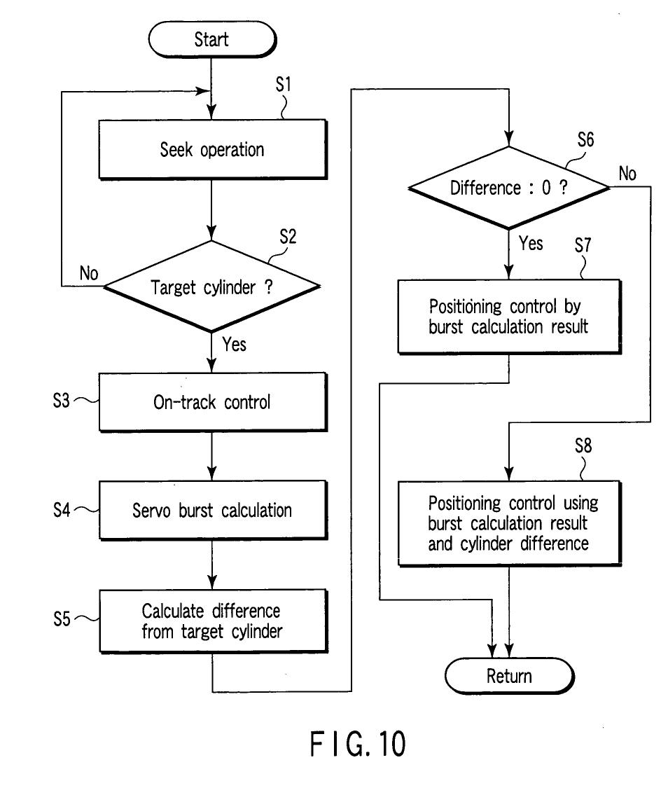

Head positioning control according to the present embodiment will be described hereinafter with reference to FIGS. 3 to 10. FIG. 10 is a flowchart showing a procedure of the head positioning control executed by the CPU 20.

First, when a target track to be read/write-accessed is designated among tracks on the disk 10, the CPU 20 executes a seek operation (seek control) to move the head 12 to the target track (step S1). In the seek control, the CPU 20 executes a calculation to calculate a difference between the cylinder code (target cylinder) of the target track and the cylinder code (current track position) read by the head 12. A distance to the target cylinder, for which the head 12 is to move, is obtained by the calculation.

When the head 12 moves to the target cylinder, the CPU 20 shifts to a track control from the seek control (YES in steps S2, S3). Here, even at the time of the seek operation, the CPU 20 detects the position of the head 12 in the track using a result of the servo burst calculation, and acquires the cylinder code at the time when the head 12 is positioned at the center of the track.

Here, a method of detecting the position of the head 12 by the servo burst calculation will be described with reference to FIG. 3.

In FIG. 3, N−1, N, N+1 mean central positions of the tracks corresponding to cylinder codes N−1, N, N+1, and Tp means a track pitch (track range). Moreover, A, B, C, D mean output values (amplitude values) indicating that the servo burst signals (A to D) are read by the head 12, and sample-held.

As shown in FIG. 3, when the position of the head 12 is in the vicinity of positions X2 to X4 on the track N, the CPU 20 can calculate position information (position error value PE from a track central position X3) from a calculation result normalized by a servo burst calculation “(A−B)/(A+B)”.

Here, a relation between the track pitch Tp and the width Tw of the head 12 is, in general, “Tp>Tw”. Therefore, when the head 12 is positioned in the vicinity of a position X5, a head output value corresponding to the burst B is constantly 0. Therefore, the CPU 20 is insensitive to a position shift of the head 12, and correct position information (position error value PE with respect to a center X3) cannot be obtained. Therefore, the CPU 20 executes a servo burst calculation “(C−D)/(C+D)” using the bursts C, D, and obtains position information on the basis of the position X5 from the calculation result.

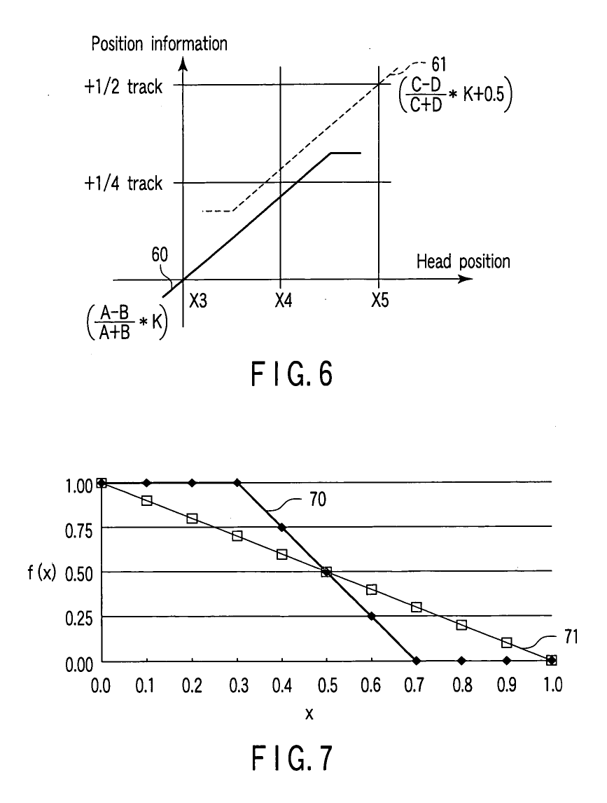

FIG. 4 shows a relation between the head position and the servo burst calculation result.

However, the position information calculated by the servo burst calculation is larger than an actual position shift amount, because the head width Tw is smaller than the track pitch Tp. Therefore, the CPU 20 multiplies the information by a position conversion coefficient K for converting the servo burst signal into the position information to correct the information. That is, the CPU 20 executes a servo burst calculation “((A−B)/(A+B))×K)” to obtain correct position information (position error value PE with respect to the center X3).

Additionally, in recent years, in disk drives, the head 12 has included a structure in which the read head is separate from the write head. When the position conversion coefficient K is a true value, a relation between the head position and the position information is as shown in FIG. 5. In this ideal case, the CPU 20 switches a servo burst calculation (50, 51) in such a manner as to use the bursts A, B, when the target position is on the side of the position X3 from the position X4, and to use the bursts C, D, when the target position is on the side of the position X5.

On the other hand, when the position conversion coefficient K deviates from the true value, for example, as shown in FIG. 6, it is recognized that the head is distant from an actual position the moment after the bursts to be used are switched, a transient response occurs, and the positioning control becomes unstable (60, 61). Then, in order to eliminate discontinuity of the position information by the switching of the servo burst calculation, the CPU 20 attaches weights to average calculation of the bursts A, B and the bursts C, D, and varies the weights.

Concretely, for example, since the bursts C, D are saturated in the vicinity of a center of the bursts A, B, the weights of the bursts C, D are reduced. The weights are set to be equal in the vicinity of a middle between the bursts A, B and the bursts C, D.

That is, the CPU 20 executes a servo burst calculation “PE=αAB+(1.0−α)CD”. Here, “AB” denotes a position shift amount from the track center, obtained from the bursts A, B, and “CD” denotes a position shift amount from the track center, obtained from the bursts C, D. The weight a is “0.0≦α≦1.0”.

The weight α is determined by a function f by a ratio of |AB| to |CD|. That is, the following relational equations (1), (2) are established:
α=f(0.5×|AB|/|CD|) (1),
where |AB|≦|CD|,
α=f(1.0−0.5×|CD|/|AB|) (2),
where |AB|>|CD|.

Furthermore, a domain of f(x) is “0.0≦x≦1.0”, and values are given by tables 70, 71 shown in FIG. 7. A representative value is “f(0.0)=1.0”. When the position of the head 12 is in the vicinity of the center of the bursts A, B, |AB| is used. When “f(0.5)=0.5”, and |AB| is substantially equal to |CD|, an average value of |AB| and |CD| is used. When “f(1.0)=0.0”, and the position of the head 12 is in the vicinity of the center of the bursts C, D, |CD| is used.

Other values are continuous values which complement the above-described values. When the table 70 shown in FIG. 7 is used, the position information is obtained from only AB or only CD in the vicinity of the center of the bursts A, B or the bursts C, D. The position information is obtained from an average value of AB, CD in the vicinity of a boundary of the bursts A, B or the bursts C, D. Here, since the weighting of the average continuously changes, any transient response by the switching or the like is not generated. In a region where one burst is saturated, the weight shifts to the other burst that is not saturated, and therefore the saturation does not have to be considered.

FIG. 8 shows a relation between the head position and the position information, using the weight average (the table 71 of FIG. 7). The relation does not form a complete straight line, because the weighted table gently changes and the relation is influenced by the other burst in the vicinity of the AB center or the CD center. To suppress the influence, a steep table is effective like the table 70 of FIG. 7, but a possibility occurs that the transient response is generated. Therefore, the weighted table is preferably selected in consideration of characteristics of the head for actual use.

When an actual position shift amount does not match the obtained position information by fluctuations of electromagnetic conversion characteristics in the radial direction of the head, a plurality of weighted tables are prepared beforehand, and the table is selected in accordance with a solid difference of the head. The table is shaped in such a manner that the actual position shift amount matches the position information, and accordingly linearity of the obtained position information can be improved.

According to the above-described method, a servo burst calculation result superior in the linearity is obtained, and the position can be correctly controlled in a certain specific range. Here, in the present embodiment, when the seek control shifts to the on-track control as shown in FIG. 10, position control in a case where the head 12 crosses the tracks (cylinders) is assumed.

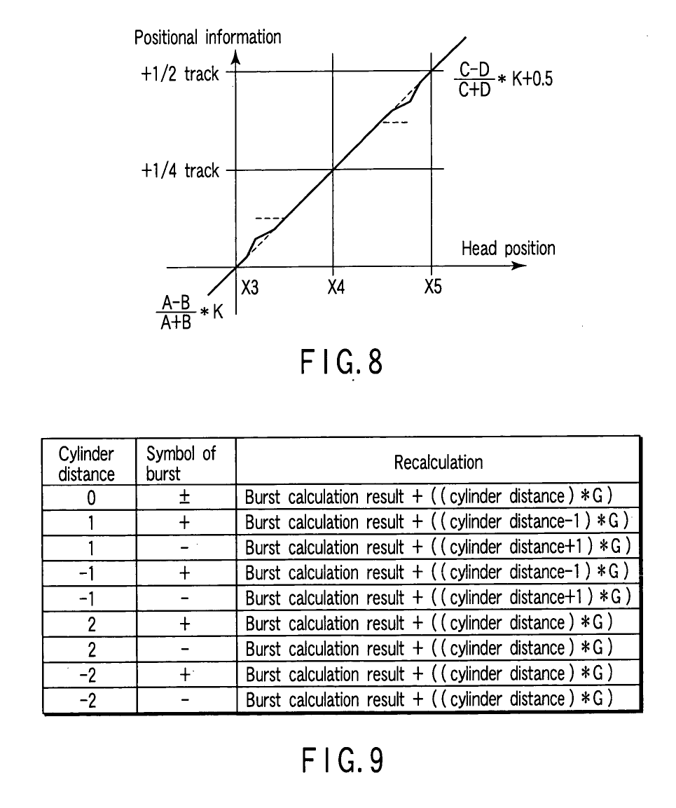

Here, the CPU 20 executes the servo burst calculation using table information shown in FIG. 9 (step S4). It is to be noted that a coefficient “G” in the table information is a coefficient (e.g., 2048) related to the gain for one track (cylinder).

The CPU 20 calculates a difference between a target cylinder and a cylinder code (current track position) read by the head 12 (step S5). This difference corresponds to a cylinder distance (cylinder number) from a track position where the head 12 is positioned to a target track which is the target cylinder.

When the calculated difference is “0”, the CPU 20 controls the actuator 13 based on the servo burst calculation result obtained by the above-described servo burst calculation to execute the position control for positioning the head 12 at the center of the target track (YES in steps S6, S7).

On the other hand, when the calculated difference is not “0”, the CPU 20 executes the position control for positioning the head 12 at the center of the target track by a servo burst calculation method corresponding to the difference value (cylinder distance) and symbol from the table information (NO in steps S6, S8). Here, the symbol indicates the track position of the head 12 on an inner peripheral side or an outer peripheral side with respect to the target track of the target cylinder.

Here, the CPU 20 restricts a difference value from the target cylinder at the time of the on-track control. The CPU may correct past servo data one sample before from transition of the cylinder code up to now., or may execute another processing.

As described above, according to the present embodiment, when the head 12 crosses the track at the time of the on-track control, calculation is executed to add or subtract the difference value as the cylinder distance from the target cylinder with respect to the servo burst calculation result, and accordingly position control not only in a track range but also in a broad range can be realized. In other words, there can be provided a servo burst calculation method effective for the position control in the broad range with a unified equation by addition/subtraction of the cylinder code with respect to the servo burst calculation result superior in linearity.

Especially when position calculation is executed using the cylinder code together with the servo burst signal especially at the time of on-track control, head positioning control capable of eliminating the transient response in the servo burst calculation or securing linearity can be realized.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A disk drive comprising:
a head to perform a read operation and a write operation of data with respect to a disk medium in which servo data including a cylinder code and a servo burst signal is recorded;
an actuator on which the head is mounted and which moves the head in a radial direction on the disk medium;
a first servo calculation unit which executes a servo burst calculation to calculate a position error of the head by use of the servo burst signal reproduced by the head at the time of on-track control to position the head on a track designated by a target cylinder code;
a second servo calculation unit which calculates a difference between a target cylinder and a current cylinder in accordance with the cylinder code reproduced by the head at the time of the on-track control; and
a controller which drives/controls the actuator to execute the on-track control of the head by use of a result of the servo burst calculation and a value of the difference.

2. The disk drive according to claim 1, wherein the controller executes the on-track control by the use of an addition result of addition of the difference value with respect to the servo burst calculation result calculated by the first servo calculation unit based on a cylinder distance which is the difference value calculated by the second servo calculation unit.

3. The disk drive according to claim 1, wherein the controller uses table information including an equation group using the servo burst calculation result and the difference value in relation to a cylinder distance which is the difference value, and executes the on-track control by the use of an equation acquired from the table information.

4. The disk drive according to claim 1, wherein the controller restricts a range of the difference values calculated by the second servo calculation unit, and executes the on-track control by the use of an addition result of addition of the difference value in the range with respect to the servo burst calculation result calculated by the first servo calculation unit.

5. The disk drive according to claim 1, wherein the second servo calculation unit and the controller are constituted of microprocessors.

6. A method of head positioning control applied to a disk drive including: a head to perform a read operation and a write operation of data with respect to a disk medium in which servo data including a cylinder code and a servo burst signal is recorded; and an actuator on which the head is mounted and which moves the head in a radial direction on the disk medium, the method comprising:
executing a servo burst calculation to calculate a position error of the head by use of the servo burst signal reproduced by the head at the time of on-track control to position the head on a track designated by a target cylinder code;
calculating a difference between a target cylinder and a current cylinder in accordance with the cylinder code reproduced by the head at the time of the on-track control; and
driving/controlling the actuator to execute the on-track control of the head by use of a result of the servo burst calculation and a value of the difference.

7. The method according to claim 6, wherein the executing of the on-track control comprises: executing the on-track control by the use of an addition result of addition of the difference value with respect to the servo burst calculation result based on a cylinder distance which is the difference value.

8. The method according to claim 6, wherein the executing of the on-track control comprises: using table information including an equation group using the servo burst calculation result and the difference value in relation to a cylinder distance which is the difference value; and executing the on-track control by the use of an equation acquired from the table information.

9. The method according to claim 6, wherein the executing of the on-track control comprises: restricting a range of the difference values; and executing the on-track control by the use of an addition result of addition of the difference value in the range with respect to the servo burst calculation result.

10. The method according to claim 6, further comprising: driving/controlling the actuator in accordance with the cylinder code reproduced by the head; and executes seek control to move the head to the target cylinder before the on-track control.
